(19) United States
(12) Patent Application Publication
(10) Pub. No.: US 2025/0342696 A1
(43) Pub. Date: Nov. 6, 2025

(54) DATA PROCESSING METHOD, DATA PROCESSING SYSTEM, AND RECORDING MEDIUM

(71) Applicant: CASIO COMPUTER CO., LTD., Tokyo (JP)

(72) Inventors: Nobuo IIZUKA, Tokyo (JP); Naotomo MIYAMOTO, Tokyo (JP); Masaaki KIKUCHI, Tokyo (JP); Taichi MURAKAMI, Tokyo (JP)

(73) Assignee: CASIO COMPUTER CO., LTD., Tokyo (JP)

(21) Appl. No.: 19/195,794

(22) Filed: May 1, 2025

(30) Foreign Application Priority Data
May 1, 2024 (JP) 2024-074453

(51) Int. Cl. G06V 20/40; G06T 7/20; G06T 7/70; G06V 10/60; H04N 19/139; H04N 19/184

(52) U.S. Cl. CPC G06V 20/44; G06T 7/20; G06T 7/70; G06V 10/60; H04N 19/139; H04N 19/184

(57) ABSTRACT

A data processing method including: detecting a movement vector MV indicating a time change in a position C of an event occurrence region E constituted by a connected pixel group of capturing pixels that output event data e having the same polarity of a change among a plurality of pieces of the event data e output from the capturing pixels; predicting observation positions P1 to P5 of the event data e output from the capturing pixel at a future observation time, based on the movement vector MV; and updating the observation positions P1 to P5 of the event data e at future observation times 0T to 4T, based on the event data e observed at the predicted observation times 0T to 4T and in the predicted observation positions P1 to P5.

### CROSS-REFERENCE TO RELATED APPLICATION

This application is based upon and claims the benefit of priority under 35 USC 119 of Japanese Patent Application No. 2024-074453, filed on May 1, 2024, the entire disclosure of which, including the description, claims, drawings, and abstract, is incorporated herein by reference in its entirety.

### FIELD OF THE INVENTION

The present disclosure relates to a data processing method, a data processing system, and a recording medium.

### BACKGROUND OF THE INVENTION

In an event camera, only when luminance changes at a certain level or higher in a capturing pixel, event data including a time of the change, a position of the pixel, and polarity of the change are output. For example, Patent Literature 1 discloses a system for capturing a specific luminance change pattern by an event camera of this kind and performing authentication.

International Publication No. WO2023/127400 discloses a technique for increasing accuracy of authentication by adopting an authentication mode in which reading can be performed by an event camera in a stationary state by using a dynamic luminance change technique for changing, in terms of time, luminance in a bright color display range and a dark color display range of an information code, and, furthermore, the information code is read only when a specific luminance change pattern is recognized.

### SUMMARY OF THE INVENTION

In order to achieve the objective described above, a data processing method according to the present disclosure is a data processing method for processing event data that are output from two-dimensionally arrayed capturing pixels, and include a position of a capturing pixel having luminance changed, a time of the change in luminance, and polarity of the change, and the data processing method includes: detecting a movement vector indicating a time change in a position of an event occurrence region constituted by a connected pixel group of the capturing pixels that output event data having the same polarity of a change among a plurality of pieces of event data output from the capturing pixels; predicting an observation position of the event data output from the capturing pixel at a future observation time, based on the movement vector; and updating the observation position of the event data output from the capturing pixel at the future observation time, based on the event data observed at the predicted observation time and in the predicted observation position.

### BRIEF DESCRIPTION OF DRAWINGS

A more complete understanding of this application can be obtained when the following detailed description is considered in conjunction with the following drawings, in which:

FIG. 1 is a block diagram illustrating a configuration of a communication system according to an embodiment;

FIG. 2A is a diagram illustrating a bit pattern of binary data to be transmitted;

FIG. 2B is a diagram illustrating one example of the binary data to be transmitted;

FIG. 3 is a diagram illustrating one example of data groups of event data;

FIG. 4 is a diagram illustrating a scene where the event data are stored in an event buffer;

FIG. 5 is a diagram illustrating one example of a unique bit pattern of a start marker;

FIG. 6 is a diagram illustrating processing of estimating an observation position, based on a tracking vector;

FIG. 7 is a diagram illustrating one example of a payload-decoding management table;

FIG. 8A is a diagram illustrating switching from the start marker to payload;

FIG. 8B is a diagram illustrating switching between a symbol in the payload and a 4 PPM symbol;

FIG. 9 is a transition diagram of a state of the 4 PPM symbol during decoding;

FIG. 10 is a diagram illustrating a scene where the tracking vector and the observation position are updated;

FIG. 11 is a block diagram illustrating a hardware configuration of a processing device in FIG. 1;

FIG. 12 is a flowchart of start marker detection processing;

FIG. 13 is a flowchart of prediction processing; and

FIG. 14 is a flowchart of decoding processing.

### DETAILED DESCRIPTION OF THE INVENTION

A communication system (a data processing system) for executing a data processing method of event data output from an event camera according to an embodiment, and the like are described with reference to drawings. Note that, in the drawings, the same or corresponding portions are denoted with the same reference signs.

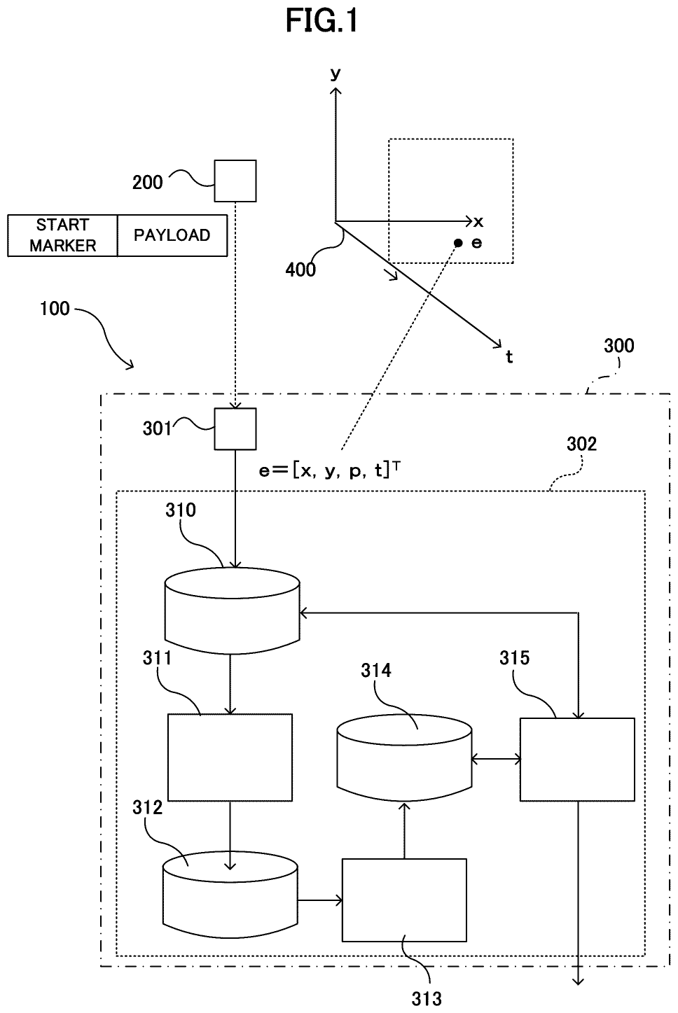

As illustrated in FIG. 1, a communication system 100 according to the embodiment includes a transmitter 200 and a receiver 300. The transmitter 200 includes a light source that can change intensity of visible light to be output. The transmitter 200 transmits binary data by the visible light as an ON/OFF signal of light emission by causing the light source to flash. In the present embodiment, time corresponding to one bit unit of the binary data to be transmitted is set as T.

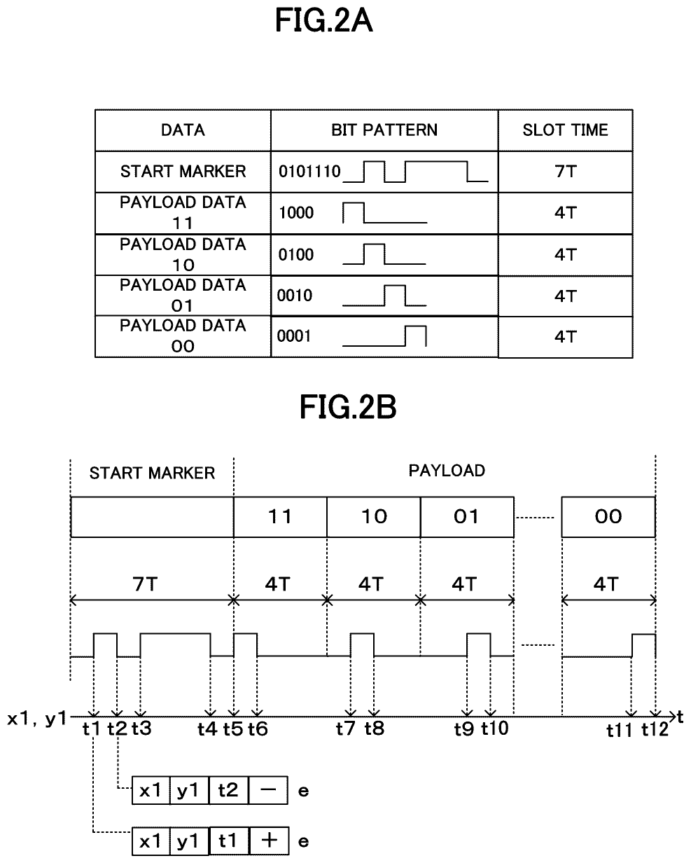

Transmission binary data are data expressed by a binary number constituted by a start marker indicating a start position of the data and payload continued from the start marker. The payload is transmitted as a symbol bit of 4 PPM subjected to conversion by a four-valued pulse-position modulation (PPM) mode described below. As illustrated in FIG. 2A, the start marker in the present embodiment is binary data expressed by a preset unique bit pattern not included in the payload subjected to the 4 PPM conversion. In the present embodiment, slot time of the start marker is set as 7T, and the unique bit pattern is defined as <0101110>. Hereinafter, the unique bit pattern is also appropriately referred to as a start pattern.

The payload is a main body of data to be transmitted. The transmitter 200 modulates the payload by a predetermined mode. In the payload, one symbol (original data symbol) before modulation is assumed to be 2 bits <11>, <10>, <01>, and <00>. The transmitter 200 modulates the binary data into data (PPM symbol) of 4 bits (slot time 4T) in order for each one symbol, that is, 2 bits. In the present embodiment, as illustrated in FIG. 2B, <11> is modulated into <1000>, <10> is modulated into <0100>, <01> is modulated into <0010>, and <00> is modulated into <0001>. For example, as illustrated in FIG. 2B, the transmitter 200 modulates payload before modulation in one symbol unit of original data, adds the start marker illustrated in FIG. 2A to a top of the modulated payload, generates binary data, and transmits a signal of the generated binary data. A frame size of the binary data to be transmitted is acquired by adding 7 bits of the start marker to a bit number acquired by multiplying a symbol number of original data symbols by 4.

The payload modulated in such a manner includes, for example, identification information about the transmitter 200 and a transmission content. The payload may include only the identification information about the transmitter 200. Note that the transmitter 200 is not limited to one, and a plurality of the transmitters 200 may simultaneously transmit the binary data. Further, the transmitter 200 may be mounted on a mobile object (not illustrated), and transmit the binary data while the mobile object is moving.

The receiver 300 includes an event camera 301 and a processing device 302. The event camera 301 includes capturing pixels being two-dimensionally arrayed. The capturing pixel of the event camera 301 detects a change in luminance in each of the capturing pixels, and outputs, as event data e, data indicating polarity (+ or −) of the change in association with a position (pixel position) of the capturing pixel that detects the change, and a time (time stamp). The event data e output from the event camera 301 include data indicating a change in luminance by the signal of the binary data transmitted from the transmitter 200, and data indicating a change in luminance due to the other factor, for example, data indicating a movement of a subject. A change p in luminance is represented by <+> or <−>. Further, a two-dimensional position coordinate system indicating a position of each of the capturing pixels is represented as an xy coordinate system, and position coordinates of the capturing pixel are represented as (x, y). Further, a time at which a luminance change is detected is set as t. In this case, the event data e are represented by the following equation.

e=(x,y,p,t)

Note that, in the event data e, an order of x, y, p, and t is not particularly limited.

As described above, the event data e are asynchronous data output from the capturing pixel when there is a change in luminance of the capturing pixel. By processing the event data output by the event camera, an event is not generated from a stationary region and a region having a small luminance change, and each pixel detects a local relative luminance change, and thus a reduction in a data amount to be transmitted and redundant transmission information, and realization of a wide dynamic range can be achieved. Generation of an event is limited to only a response speed of hardware, and thus a high time resolution can be achieved. The signal of the binary data transmitted from the transmitter 200 produces a pulse waveform as illustrated in FIG. 2B, for example. When the signal is received by a capturing pixel in a position (x1, y1) in the xy coordinate system, the event camera 301 outputs the event data e=(x1, y1, t1, +)^{T} at a time t1 in the start marker, and outputs the event data e=(x1, y1, t2, −)^{T} at a time t2. Subsequently, the event camera 301 outputs the event data e including polarity p of each change in luminance at times t3 to t12.

As illustrated in FIG. 1, the event data e output from the event camera 301 can be represented in a three-dimensional data space 400 constituted by the xy coordinate system indicating a position of the capturing pixel and a time axis t. A point in the three-dimensional data space 400 illustrated in FIG. 1 corresponds to the event data e including the position coordinates (x, y) of the capturing pixel having luminance changed in the xy coordinate system, the time t at which the luminance is changed, and the polarity p of the change. As described above, the event camera 301 outputs not only a plurality of pieces of the event data e corresponding to the binary data output from the transmitter 200, but also the plurality of pieces of the event data e corresponding to a change in luminance in the capturing pixel in which another subject is captured. The event data e produce a data group of the event data e in the three-dimensional data space 400.

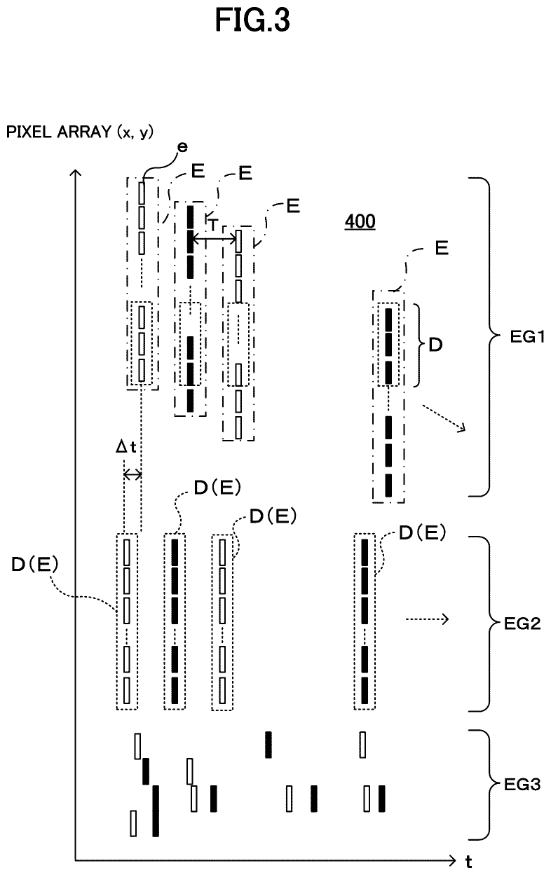

FIG. 3 illustrates one example of data groups of the event data e, in which the time t is a horizontal axis and a pixel array (x, y) arrayed in the xy coordinate system in the three-dimensional data space 400 is a vertical axis. In FIG. 3, a two-dimensional coordinate system is developed on a straight line. Pixels adjacent to each other on an image plane are assumed to be also adjacent on the straight line. In FIG. 3, a white mark represents the event data e indicating that the polarity p is <+>, that is, luminance has increased, and a black mark represents the event data e indicating that the polarity p is <−>, that is, luminance has decreased. FIG. 3 illustrates data groups EG1, EG2, and EG3 as the data groups. The data group EG1 is a data group of the event data e related to the binary data transmitted from the transmitter 200 mounted on the mobile object (not illustrated), and is a data group indicating a bit pattern of the start marker. The data group EG2 is a data group of the event data e related to the binary data transmitted from the stationary transmitter 200, and is a data group indicating a bit pattern of the start marker. The data group EG3 is a data group indicating a random change in luminance regardless of the binary data transmitted from the transmitter 200. The event camera 301 outputs the event data e in each of the data groups EG1 to EG3. The data groups EG1 to EG3 are the pieces of the binary data transmitted from the different transmitters 200, and are thus asynchronous to each other, and a time difference At not being an integral multiple of the unit time T may be generated.

The processing device 302 processes the data groups of the event data e in the three-dimensional data space 400. The processing device 302 extracts the event data e transmitted from the transmitter 200 from the data groups. In the example illustrated in FIG. 3, the processing device 302 extracts the event data e in the data groups EG1 and EG2 corresponding to the binary data transmitted from the transmitter 200 among the data groups EG1 to EG3. The data group EG3 of the event data e randomly occurring is deleted. The processing device 302 demodulates the binary data transmitted from the transmitter 200, based on the extracted event data e. In the example illustrated in FIG. 3, the processing device 302 demodulates the binary data, based on the event data e constituting the data groups EG1 and EG2.

In order to extract and demodulate the binary data transmitted from the transmitter 200, as illustrated in FIG. 1, the processing device 302 includes an event buffer 310, a start marker matching filter 311, a bit pattern memory 312, an observation position filter (detecting unit and predicting unit) 313, a payload decoding management table 314, and a payload decoder (updating unit) 315. The event buffer 310, the bit pattern memory 312, and the observation position filter 313 are constituted by an arithmetic device that performs a computation, and the event buffer 310, the bit pattern memory 312, and the payload decoding management table 314 are constituted by a storage device or a recording medium that stores data.

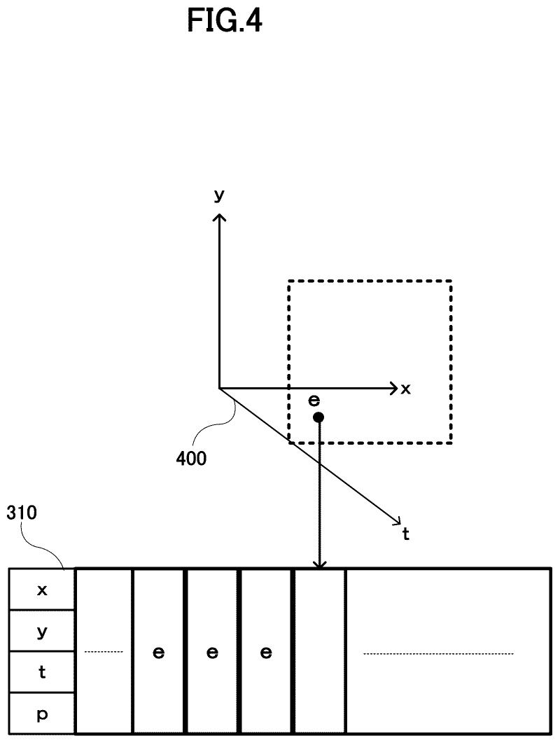

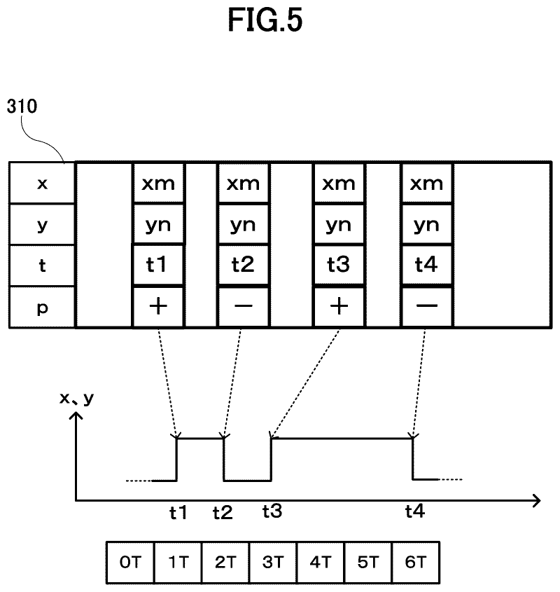

The event buffer 310 is a buffer memory that temporarily stores the plurality of pieces of the event data e output from the capturing pixels. As illustrated in FIG. 4, the event buffer 310 stores, in an output order of the event data e, the event data e indicating one point in the three-dimensional data space 400. The event buffer 310 limits a time range in which the pieces of the event data e corresponding to the same xy position are simultaneously stored to six unit times T (6T). The reason is that the event buffer 310 needs 6T of a memory capacity of the event buffer 310 in order to detect the start marker illustrated in FIGS. 2A and 5 and having the slot time of 7T. Note that the time range in which the pieces of the event data e corresponding to the same xy position are simultaneously stored is not limited to 6T, and may be a time range in which detection of the start marker is possible.

The start marker matching filter 311 determines whether a bit pattern indicating time fluctuations in luminance and being constituted by the event data e indicating the same xy position among the plurality of pieces of the event data e temporarily stored in the event buffer 310 coincides with the unique bit pattern of the start marker illustrated in FIG. 2A. FIG. 5 illustrates a bit pattern based on the polarity p of the change and the time t in the event data e for 6T indicating a position (xm, yn). The start marker matching filter 311 detects the xy position coinciding with the unique bit pattern of the start marker as illustrated in FIG. 5. The start marker matching filter 311 specifies a region of a connected pixel group in which a bit pattern indicating time fluctuations in luminance coincides with the unique bit pattern of the start marker illustrated in FIG. 2A. The connected pixel group is a pixel group constituting one region by continuous capturing pixels in the xy coordinate system, and is a pixel group constituting a certain region and being continuously disposed. The region is a superimposition region D where an event occurrence region E (see FIG. 3) described below overlaps in the direction of the time axis t. The superimposition region D is a reference for detecting the data groups EG1 and EG2 illustrated in FIG. 3. In the example illustrated in FIG. 3, the start marker matching filter 311 detects the superimposition region D individually from the data groups EG1 and EG2. The data groups EG1 and EG2 are divided into groups, based on the detected superimposition region D.

The bit pattern memory 312 stores the bit pattern indicating the time fluctuations in luminance in the capturing pixels located in the superimposition region D specified by the start marker matching filter 311. For example, the bit pattern memory 312 stores the bit pattern indicating the time fluctuations in luminance in the capturing pixels in the same xy position, based on the event data e as illustrated in FIG. 3.

The observation position filter 313 specifies, as the event occurrence region E, a region including the superimposition region D and being constituted by the connected pixel group that outputs the event data e having the same polarity p of the change as the superimposition region D, based on the plurality of pieces of the event data e temporarily stored in the event buffer 310. In the example illustrated in FIG. 3, at each time t, a region including the superimposition region D and being constituted by the connected pixel group having the same polarity p of the change as the superimposition region D is specified as the event occurrence region E. A position of the event occurrence region E corresponding to the data group EG1 changes as the time passes, and thus the event occurrence region E at each time t is acquired by the other region connected to the superimposition region D. On the other hand, a position of the event occurrence region E corresponding to the data group EG2 does not change in terms of time, and thus the event occurrence region E generated at each time t is the same as the superimposition region D.

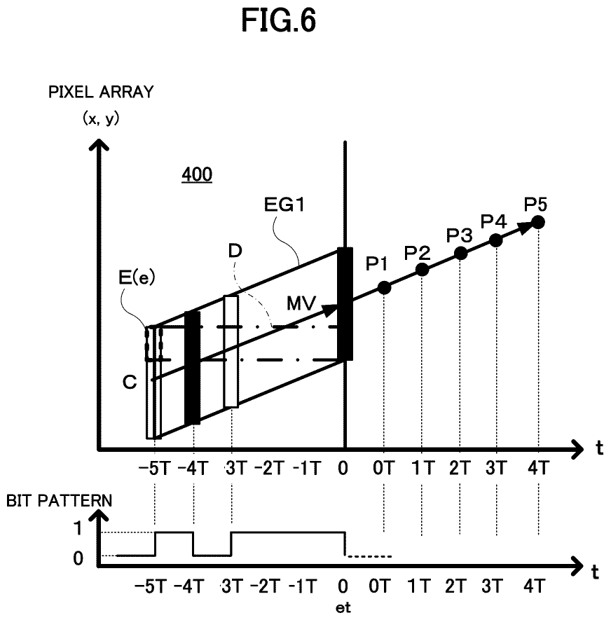

As a result, the event occurrence region E is a plane region in the xy coordinate system constituted by the connected pixel group of the capturing pixels that output the event data e having the same polarity of the change among the plurality of pieces of the event data e output from the capturing pixels. The observation position filter 313 generates the event occurrence region E at each time t. The observation position filter 313 detects a time change in a position of the event occurrence region E, based on a position of the event occurrence region E at different times t. As illustrated in FIG. 3, a position of the event occurrence region E in the data group EG1 changes as the time passes. Herein, for example, as illustrated in FIG. 6, a time of the event data e indicating a bit on a last falling edge of the unique bit pattern of the start marker is set as an origin 0, time before the origin 0 is represented as −1T, −2T, . . . , and time after the origin 0 is represented as 0T, 1T, 2T, . . . . Based on a representative position (for example, a center position) C of the event occurrence region E at −5T and a representative position (for example, a center position) C of the event occurrence region E constituted by the same connected pixel group at the origin 0, the observation position filter 313 detects a movement vector (tracking vector) MV connecting the representative positions as information indicating time fluctuations in a position of the event occurrence region E. The tracking vector MV is a vector indicating a position to and a time at which the event occurrence region E moves. Note that, in the present embodiment, a time change in a position of the event occurrence region E between −5T and 0 is calculated as the tracking vector MV, which is not limited thereto. In this way, the observation position filter 313 detects time fluctuations (tracking vector MV) in a position of the event occurrence region E that is a region in a plane of the xy coordinate system in the three-dimensional data space 400 and is constituted by the event data e having the same polarity p of the change among the plurality of pieces of the event data e output from the capturing pixels.

Furthermore, the observation position filter 313 predicts the observation position (x, y) of the event data e output from the capturing pixels at a future observation time t from the capturing pixels, based on the detected tracking vector MV. For example, as illustrated in FIG. 6, the observation position filter 313 predicts, for the data group EG1, observation positions P1 to P5 at the observation times 0T to 4T at an interval of the unit time T by extending the tracking vector MV. The observation position filter 313 predicts the observation position (x, y) at the observation time t in the three-dimensional data space 400 individually for the data group EG1 and the data group EG2.

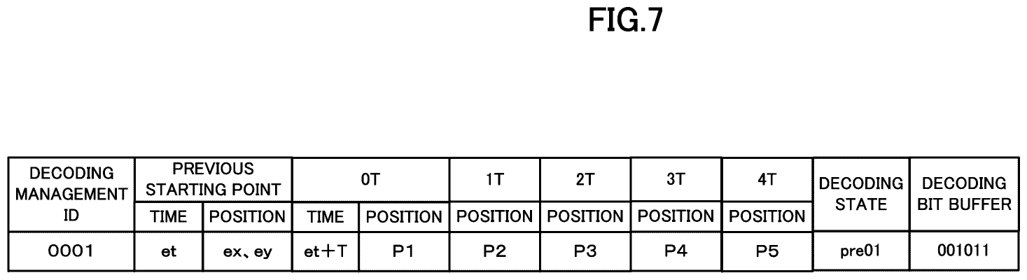

The observation positions P1 to P5 of the data groups of the event data e occurring in the future in the three-dimensional data space 400 are registered in the payload decoding management table 314. For example, as illustrated in FIG. 7, a decoding management ID (identification), a time et and a position (ex, ey) of a previous starting point, a time et+T and the observation position P1 at 0T, and the observation positions P2 to P5 at 1T to 4T are stored in the payload decoding management table 314. The observation position filter 313 provides the decoding management ID to each data group, and registers each data group in the payload decoding management table 314. For example, in the example illustrated in FIG. 3, an individual decoding management ID is provided to each of the data groups EG1 and EG2.

The observation position filter 313 registers, as the time et and the position (ex, ey) of the previous starting point, the time t corresponding to the origin 0 in FIG. 6, and the center position C of the event occurrence region E at the time t, that is, an end point of the tracking vector MV. For example, the time t4 in FIG. 5 is registered as the time et of the previous starting point of the payload decoding management table 314, and the center position C of the event occurrence region E at the time t4 is registered as the position (ex, ey). Furthermore, as described above, the observation position filter 313 registers, as the time at 0T, the time (et+T) acquired by adding T to the time et of the previous starting point. Furthermore, the observation position filter 313 registers the observation positions P1 to P5 each predicted at the times 0T to 4T in the payload decoding management table 314.

The payload decoder 315 performs decoding of bit patterns corresponding to the plurality of pieces of the event data e observed at the predicted observation times 0T to 4T and in the predicted observation positions P1 to P5 among the pieces of the event data e newly output from the capturing pixels. For example, in the examples illustrated in FIGS. 6 and 7, decoding of bit patterns constituted by the event data e indicating the observation time et+T and the observation position P1, the event data e indicating an observation time et+2T and the observation position P2, the event data e indicating an observation time et+3T and the observation position P3, the event data e indicating an observation time et+4T and the observation position P4, and the event data e indicating an observation time et+5T and the observation position P5 is performed.

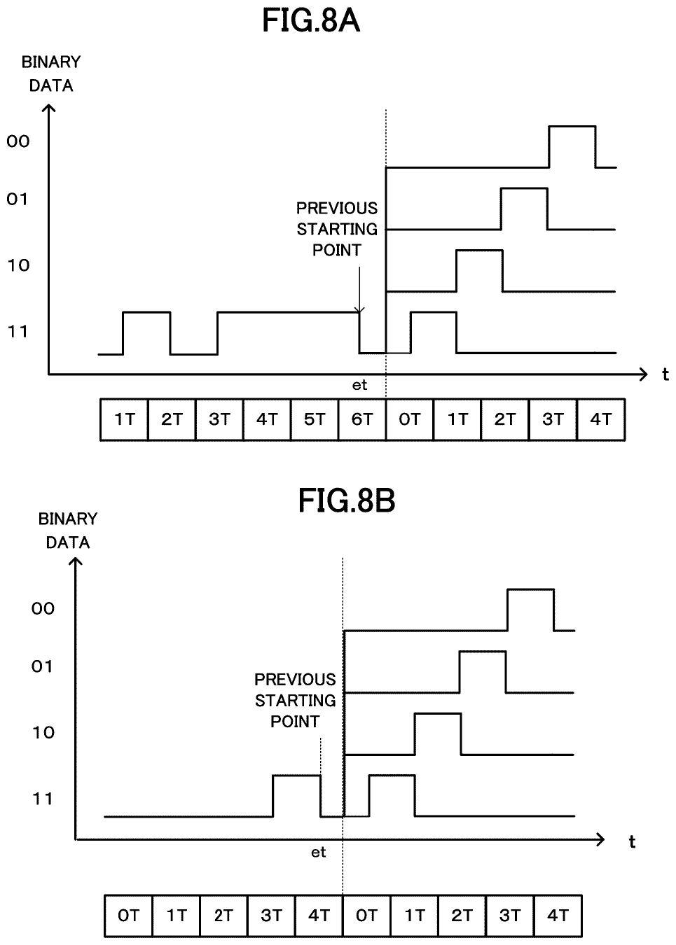

For example, as illustrated in FIG. 8A, at a timing at which the start marker ends, the payload decoder 315 recognizes timings of a rising edge <+> and a falling edge <−> of a signal of payload after modulation at 0T to 4T, and registers a decoded bit pattern in the decoding bit buffer. Specifically, when a signal rises at 3T and falls at 4T, the payload decoder 315 additionally registers <00> in the decoding bit buffer of the payload decoding management table 314. Further, when a signal rises at 2T and falls at 3T, the payload decoder 315 additionally registers <01> in the decoding bit buffer of the payload decoding management table 314. Further, when a signal rises at 1T and falls at 2T, the payload decoder 315 additionally registers <10> in the decoding bit buffer of the payload decoding management table 314. Further, when a signal rises at 0T and falls at 1T, the payload decoder 315 additionally registers <11> in the decoding bit buffer of the payload decoding management table 314.

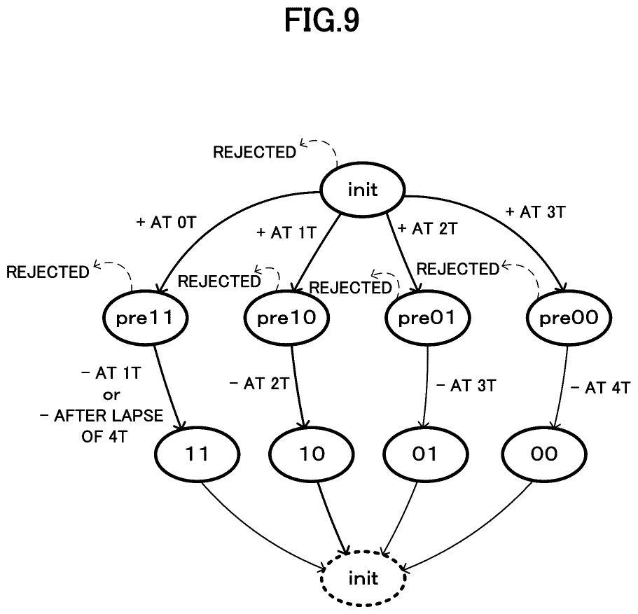

As a state transition diagram illustrated in FIG. 9, each time the event data e are input at the predicted observation times 0T to 4T and in the predicted observation positions P1 to P5, the payload decoder 315 performs decoding while causing a transition of a decoding state of the 4 PPM symbol in the payload decoding management table 314, based on the input event data e. As illustrated in FIG. 9, the decoding state of the 4 PPM symbol before a decoding start is set as an initial state (init). When a signal rises at 0T, the payload decoder 315 causes the decoding state of the 4 PPM symbol in the payload decoding management table 314 to transition to pre 11. Further, when a signal falls at 1T, or 4T has elapsed without falling, the payload decoder 315 additionally registers <11> in the decoding bit buffer in the payload decoding management table 314. Similarly, when the state becomes <+> at 1T, the payload decoder 315 causes the decoding state of the 4 PPM symbol to transition to pre10. Subsequently, when the state becomes <−> at 2T, the payload decoder 315 additionally registers <10> in the decoding bit buffer. When the state becomes <+> at 2T, the payload decoder 315 causes the decoding state of the 4 PPM symbol to transition to pre01. When the state becomes <−> at 3T, the payload decoder 315 additionally registers <01> in the decoding bit buffer. When the state becomes <+> at 3T, the payload decoder 315 causes the decoding state of the 4 PPM symbol to transition to pre00. When the state becomes <−> at 4T, the payload decoder 315 additionally registers <00> in the decoding bit buffer. After additional registration to the decoding bit buffer, the decoding state returns to init. Except for the state of pre11, when the time 4T has elapsed in midstream, the payload decoder 315 rejects a bit pattern being a decoding target.

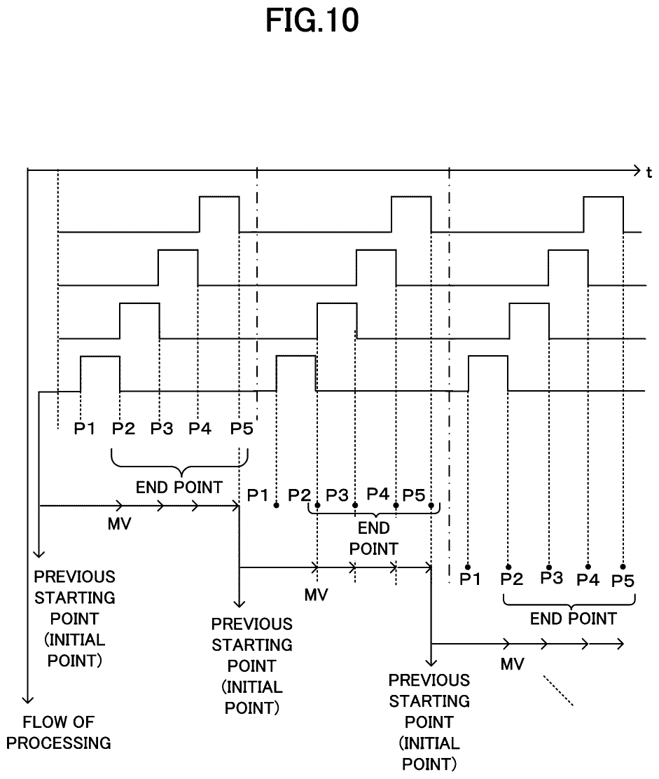

Furthermore, the payload decoder 315 further predicts the observation position (x, y) at the future observation times 0T to 4T, based on the event data e observed at the future observation times 0T to 4T and in the observation positions P1 to P5, and updates the observation positions P1 to P5 of the event data e output from the capturing pixels at the future observation times 0T to 4T. More specifically, as illustrated in FIG. 10, the payload decoder 315 calculates the tracking vector MV in the 4 PPM symbol this time from the time et and the position (ex, ey) of the previous starting point being registered in the payload decoding management table 314, and a time and a position in which the state becomes <−> in the 4 PPM symbol this time. An end point of the tracking vector MV is any of P2 to P5 according to a falling position in the bit pattern of the 4 PPM symbol. The payload decoder 315 predicts the observation positions P1 to P5 in a next 4 PPM symbol, based on the calculated tracking vector MV. The predicted observation positions P1 to P5 are registered in the payload decoding management table 314. The time 4T and the observation position P5 predicted in the 4 PPM symbol this time are registered as the time et and the position (ex, ey) of the previous starting point in the payload decoding management table 314.

In this way, based on the plurality of pieces of the event data e observed in the predicted observation positions P1 to P5 at the predicted observation times 0T to 4T among the pieces of the event data e newly output from the capturing pixels, the payload decoder 315 repeatedly performs decoding of bit patterns constituted by the plurality of pieces of the event data e, and prediction of the observation positions P1 to P5 based on the plurality of pieces of the event data e. In this way, the processing device 302 narrows down the event data e to only the data groups EG1 and EG2 in which the start marker is detected, and narrows down the event data e being a decoding target to the predicted observation position (x, y) of the event data e in the three-dimensional data space 400. By the narrowing-down, processing time required for decoding can be shortened.

In a process of the narrowing-down, the start marker matching filter 311 deletes the event data that do not produce the preset unique bit pattern from the event buffer 310. Furthermore, the observation position filter 313 deletes, from the event buffer 310, the event data e indicating a position included in the event occurrence region E where time fluctuations in a position of the event occurrence region E are detected. Thus, a memory capacity needed for decoding can be reduced. In the present embodiment, the start marker matching filter 311 detects a position of the event occurrence region E in a time unit corresponding to one bit of a bit pattern (bit pattern after modulation) of the binary data to be transmitted. Further, the observation position filter 313 predicts the observation positions P1 to P5 in a time unit corresponding to one bit of the bit pattern of the binary data to be transmitted.

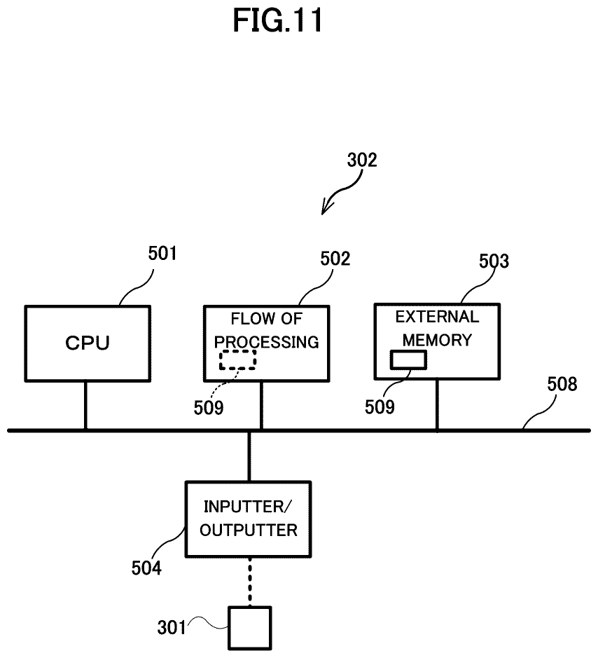

The processing device 302 illustrated in FIG. 1 is realized by, for example, realizing a software program by a computer having a hardware configuration illustrated in FIG. 11. Specifically, the processing device 302 is constituted by a central processing unit (CPU) 501 that has control over the entire device, a main memory 502 set in motion as a workspace of the CPU 501 and the like, an external memory 503 that stores a program 509 executed by the CPU 501 and the like, an inputter/outputter 504, and an internal bus 508 that connects these components. The processing device 302 may be constituted by a combination of a CPU (not illustrated) being different from the CPU 501 and specializing in specification processing of event data, and a circuit for demodulating and combining the event data, or the CPU 501 may function as an arithmetic processor.

The CPU 501 is a processor that realizes the function of the processing device 302 by executing the program 509. The main memory 502 is constituted by a random access memory (RAM) and the like. The program 509 executed by the CPU 501 is loaded into the main memory 502 from the external memory 503. The main memory 502 is also used as a workspace (transitory storage area of data) of the CPU 501. The external memory 503 is constituted by a non-volatile memory such as a flash memory and a hard disk. The program 509 to be executed by the CPU 501 is stored in advance in the external memory 503.

The inputter/outputter 504 is an interface that performs data transmission/reception to and from an external apparatus. The event data e output from the event camera 301 are input via the inputter/outputter 504. The function of the processing device 302 can be implemented on a calculator system constituted by one or more computers that include one or more processors and one or more storage devices including a non-transitory recording medium. The plurality of computers realizes the function of the processing device 302 while performing communication via communication networks connected to each other. For example, a part of the plurality of functions of the processing device 302 may be implemented on one computer, and the other part may be implemented on the other computer.

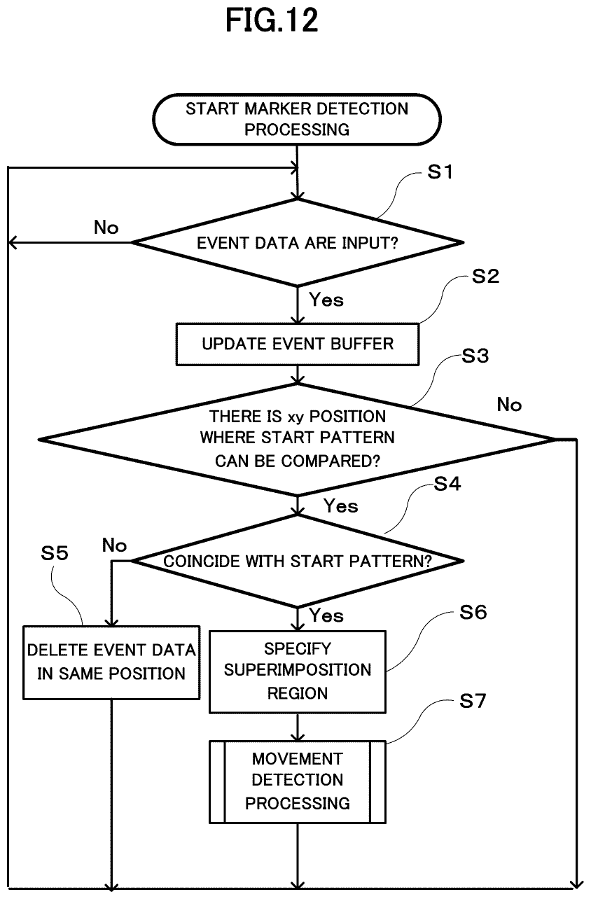

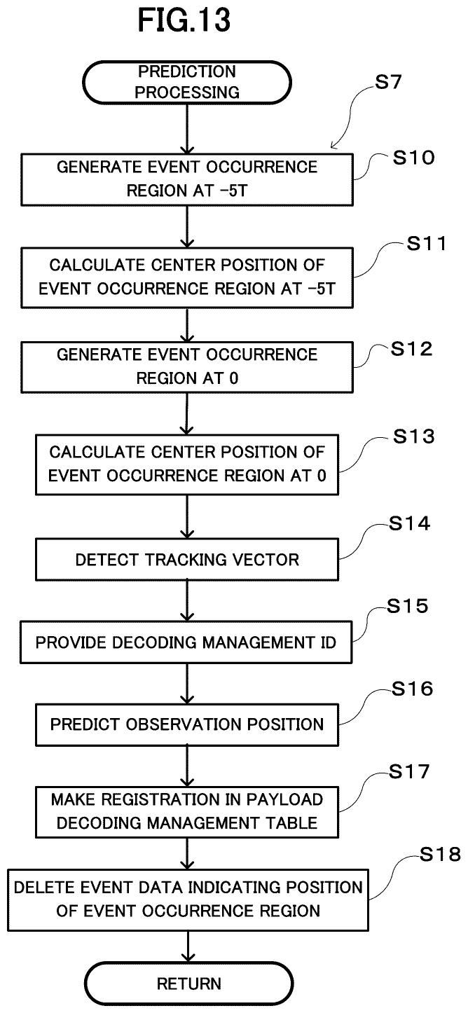

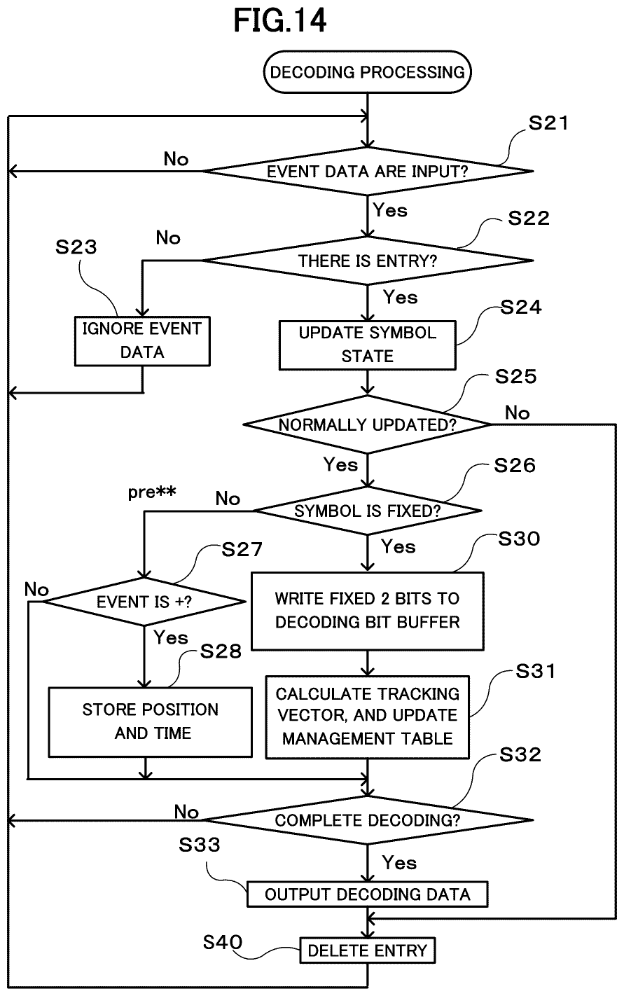

Next, a data processing method executed by the processing device 302 in the communication system 100 according to the present embodiment is described. The data processing method includes start marker detection processing illustrated in FIG. 12, prediction processing illustrated in FIG. 13, and decoding processing illustrated in FIG. 14. First, start decoding detection processing is described. As illustrated in FIG. 12, the start marker matching filter 311 waits until the event data e are input (step S1; No). When the event data e are input (step S1; Yes), the start marker matching filter 311 updates a content to be stored in the event buffer 310 (step S2). Specifically, the start marker matching filter 311 stores the input event data e in the event buffer 310, and also deletes, from the event buffer 310, event data indicating the same position as the position indicated by the input event data e and indicating the time t before 6T.

The start marker matching filter 311 determines whether there is an xy position where a bit pattern based on the event data e stored in the event buffer 310 can be compared with a start pattern (step S3). When the event data e indicating the same xy position are stored in the event buffer 310 for 6T, the determination herein is positive.

When there is no xy position where the bit pattern and the start pattern can be compared (step S3; No), the start marker matching filter 311 waits until the event data e are input (step S1; No). Subsequently, each time the event data e are input (step S1; Yes), updating of the event buffer 310 (step S2) and determination whether the start pattern can be compared (step S3) are repeated. When there is a position where the bit pattern and the start pattern can be compared (step S3; Yes), the start marker matching filter 311 stores, in the bit pattern memory 312, the bit pattern indicating time fluctuations in luminance for 6T in the same position, and determines whether the stored bit pattern coincides with the start pattern (step S4). When the bit pattern indicating time fluctuations in luminance for 6T in the same position does not coincide with the start pattern (step S4; No), the start marker matching filter 311 deletes the event data e in the same position (step S5), and waits again for an input of the next event data e (step S1; No).

On the other hand, when the bit pattern indicating time fluctuations in luminance for 6T in the same position coincides with the start pattern (step S4; Yes), the start marker matching filter 311 specifies, as the superimposition region D (see FIG. 3) where the event occurrence region E overlaps in the direction of the time axis t, a region where the bit pattern being constituted by the event data e indicating the same position, and indicating time fluctuations in luminance coincides with the unique bit pattern (start pattern) (step S6). Subsequently, the observation position filter 313 performs a subroutine of movement detection processing (step S7).

As illustrated in FIG. 13, in the movement detection processing in step S7, the observation position filter 313 generates the event occurrence region E at −5T as illustrated in FIG. 6 by using the bit pattern memory 312 (step S10). Subsequently, the observation position filter 313 calculates the center position C of the event occurrence region E at −5T (step S11). Subsequently, the observation position filter 313 generates the event occurrence region E at 0 (step S12). Subsequently, the observation position filter 313 generates the center position C of the event occurrence region E at 0 (step S13). Subsequently, the observation position filter 313 detects the tracking vector MV, based on the center position C of the event occurrence region E at −5T and the center position C of the event occurrence region E at 0 (step S14). Subsequently, the observation position filter 313 provides a decoding management ID to a data group constituted by the series of the detected event occurrence regions E (step S15). In a case of the example illustrated in FIG. 3, a decoding management ID is provided to each of the data group EG1 and the data group EG2. For example, as illustrated in FIG. 7, a decoding management ID 0001 is provided to the data group EG1.

Subsequently, the observation position filter 313 predicts the observation positions P1 to P5 (step S16). Subsequently, the observation position filter 313 registers, in the payload decoding management table 314, the time et and the position (ex, ey) of the previous starting point and the predicted observation times 0T to 4T (et+T to et+5T) and the predicted observation positions P1 to P5 (step S17). Note that, in this stage, a decoding state of the payload decoding management table 314 is initialized to init, and nothing is registered in the decoding bit buffer. Subsequently, the observation position filter 313 deletes, from the event buffer 310, the event data e indicating the xy position corresponding to the event occurrence region E (step S18). After execution of step S18, the observation position filter 313 ends the subroutine of the movement detection processing. Returning to FIG. 12, after execution of the subroutine of the movement detection processing (step S7), the start marker matching filter 311 waits for an input of the event data e (step S1; No).

The decoding processing is executed by the payload decoder 315 simultaneously with the start marker detection processing (see FIG. 12) and the prediction processing (see FIG. 13). As illustrated in FIG. 14, the payload decoder 315 first waits until the event data e are input (step S21; No). When the event data e are input (step S21; Yes), the payload decoder 315 determines whether there is an entry in the payload decoding management table 314, that is, whether the time et and the position ex, ey of the previous starting point and the predicted observation positions P1 to P5 at 0T to 4T (et+T to et+5T) are input (step S22). Herein, when there is no entry in the payload decoding management table 314 (step S22; No), the payload decoder 315 ignores the event data e and does not perform decoding (step S23). When there is an entry in the payload decoding management table 314 (step S22; Yes), the payload decoder 315 updates a symbol state of the 4 PPM symbol (step S24). Updating of the symbol state of the 4 PPM symbol is performed according to the transition diagram of the symbol state illustrated in FIG. 9. For example, when a signal becomes <+> at 0T, the symbol state of the 4 PPM symbol is caused to transition from init to pre 11.

Subsequently, the payload decoder 315 determines whether the symbol state of the 4 PPM symbol is normally updated (step S25). For example, it is determined that the symbol state is normally updated when init is updated to pre11, pre10, pre01, or pre00, or pre11, pre10, pre01, or when pre00 is changed to init. When it is determined that the symbol state is not normally updated (step S25; No), the payload decoder 315 deletes the entry of the payload decoding management table 314 (step S40), and waits for an input of the event data e (step S21; No).

When it is determined that the symbol state is normally updated (step S25; Yes), the payload decoder 315 determines whether the symbol after modulation is in a fixed state (step S26). When the symbol after modulation is not in the fixed state (step S26; No), that is, when the symbol state of the 4 PPM symbol is pre** (** is any of 00 to 11), the payload decoder 315 determines whether the polarity p of the change in the event data e is <+> (step S27). When the polarity p of the change in the event data e is <+> (step S27; Yes), the payload decoder 315 stores the time t and the position (x, y) indicated by the event data e as the time et and the position (ex, ey) of the previous starting point to be used for next decoding of the 4 PPM symbol of the payload decoding management table 314 (step S28). On the other hand, when the polarity p of the change in the event data e is not <+> (step S27; No), the payload decoder 315 does nothing, and the processing proceeds to step S32.

On the other hand, when the symbol after modulation is in the fixed state (step S26; Yes), the payload decoder 315 writes the fixed 2 bits to the decoding bit buffer (step S30). Furthermore, the payload decoder 315 updates the tracking vector MV, based on the time et and the position (ex, ey) of the previous starting point being registered in the payload decoding management table 314 and the times 0T to 4T (et+T to et+5T) and the positions P1 to P5 of the event data e this time; rewrites the predicted observation time et+t and the predicted observation position P1 corresponding to 0T and the predicted observation positions P2 to P5 corresponding to 1T to 4T, based on the updated tracking vector MV; and updates the payload decoding management table 314 (step S31).

After the determination in step S27 is negative or after execution of steps S28 and S31, the payload decoder 315 determines whether to complete frame decoding (step S32). The determination can be performed by whether a fixed time has elapsed without an input of the event data e. When decoding is not completed (step S32; No), the payload decoder 315 waits for an input of the event data e (step S21; No).

When decoding is completed (step S32; Yes), the payload decoder 315 outputs binary data accumulated in the decoding bit buffer of the payload decoding management table 314 (step S33). Subsequently, the payload decoder 315 deletes the entry registered in the payload decoding management table 314 (step S40). After execution of step S40, the payload decoder 315 waits for an input of the event data e (step S21; No).

In the processing device 302 according to the present embodiment, the payload decoder 315 sets, as a decoding target, only the event data e indicating the predicted observation times 0T to 4T and the predicted observation positions P1 to P5. However, the present disclosure is not limited to this. The event data e indicating a position included in a predetermined time range and a predetermined region with reference to the predicted observation times 0T to 4T and the predicted observation positions P1 to P5 may be included as the decoding target. For example, the event data e indicating a position included in the event occurrence region E can be set as the decoding target. In this way, a case where a speed and a movement direction of the mobile object on which the transmitter 200 is mounted change can also be handled, and a time change in a curved manner and a non-linear manner in addition to a straight line in a position of the event occurrence region E can also be handled.

As described above in detail, in the data processing method according to the embodiment described above, the processing device 302 executes the start marker detection processing (see FIG. 12) as a detection step, the prediction processing (see FIG. 13) as a prediction step, and the decoding processing (see FIG. 14) as an updating step and a decoding step. The start marker detection processing (see FIG. 12) includes detecting the tracking vector MV indicating a time change in a position of the event occurrence regions EG1 and EG2 constituted by a connected pixel group of capturing pixels that output the event data e having the same polarity p of the change among the plurality of pieces of the event data e output from two-dimensionally arrayed capturing pixels. The prediction processing (see FIG. 13) includes predicting the observation positions P1 to P5 (FIGS. 6 and 7) of the event data e output from the capturing pixel at a future observation time, based on the tracking vector MV. The decoding processing (see FIG. 14) includes updating the observation positions P1 to P5 of the event data e output from the capturing pixel at the future observation times 0T to 4T, based on the event data e observed at the observation times 0T to 4T and in the observation positions P1 to P5 that are predicted in the prediction processing.

Further, according to the data processing method according to the embodiment described above, the processing device 302 includes the event buffer 310 that temporarily stores the plurality of pieces of the event data e output from the capturing pixels. The start marker detection processing includes specifying, as the superimposition region D where the event occurrence region E overlaps in the direction of the time axis t, a region of the connected pixel group where a bit pattern indicating time fluctuations in luminance and being constituted by the event data e indicating the same position among the plurality of pieces of the event data e temporarily stored in the event buffer 310 coincides with a preset unique bit pattern. Furthermore, the start marker detection processing includes specifying, as the event occurrence region E at the time based on the plurality of pieces of the event data e temporarily stored in the event buffer 310, a region including the superimposition region D and being constituted by a connected pixel group having the same polarity p of a change as the superimposition region D. Furthermore, the start marker detection processing includes detecting the tracking vector MV, based on a position of the event occurrence region E at a different time. In this way, the event data e being a decoding target can be narrowed down to the data groups EG1 and EG2 of the event data e having the start marker at a top.

According to the data processing method according to the embodiment described above, the start marker detection processing includes deleting, from the event buffer 310, the event data e that do not produce the unique bit pattern. In this way, a memory capacity of the event buffer 310 can be reduced.

According to the data processing method according to the embodiment described above, the event data e indicating a position included in the event occurrence region E where time fluctuations in a position are detected are deleted from the event buffer 310. In this way, a memory capacity of the event buffer 310 can be reduced.

According to the data processing method according to the embodiment described above, the start marker detection processing as a detection step includes detecting a position (center position C) of the event occurrence region E in a time unit corresponding to one bit of a bit pattern after modulation, and the prediction processing as a prediction step includes predicting the observation position (x, y) in a time unit corresponding to one bit of a bit pattern after modulation. In this way, a movement of the data groups EG1 and EG2 of the series of the event data e can be accurately detected.

A change in luminance detected by the event camera includes, in a mixed manner, a noise component due to data transmitted through visible light communication, and a noise component due to the other factor such as a movement of a subject. The noise component may increase a capacity of a memory that stores a change in luminance detected by the event camera, may cause an increase in load on arithmetic processing, and may hinder an improvement in a communication speed. The communication system 100 according to the embodiment described above is made under the circumstances described above, and makes data processing of visible light communication using the event camera more efficient.

In the communication system 100 according to the embodiment described above, 4 PPM is adopted as a modulation mode. However, the other modulation mode may be adopted. For example, as a modulation mode, amplitude shift keying (ASK), phase shift keying (PSK), and sinusoidal amplitude modulation (QAM) can be adopted.

Note that the communication system 100 according to the embodiment described above performs optical communication by visible light, but may perform communication by light other than visible light or a radio wave, for example, infrared light, ultraviolet light, and a terahertz wave. A hardware configuration and a software configuration of the processing device 302 are one example, and a change and modification can be freely made.

A main portion that executes processing of the processing device 302 constituted by the CPU 501, the main memory 502, the external memory 503, the inputter/outputter 504, the internal bus 508, and the like can be realized by using a normal computer system regardless of a dedicated system. For example, the processing device 302 that executes the processing described above may be constituted by storing and distributing a computer program for executing the motion described above into a computer-readable recording medium (such as a flexible disk, a CD-ROM, and a DVD-ROM), and installing the computer program on a computer. The processing device 302 may be constituted by, for example, storing the computer program in advance in a storage device included in a server device on a communication network such as the Internet, and downloading the computer program by a normal computer system.

For example, when the function of the processing device 302 is realized by sharing of an operating system (OS) and an application program or cooperation with the OS and the application program, only the application program portion may be stored in a recording medium or a storage device. The processing device 302 is constituted by any single processor such as a single processor, a multiprocessor, and a multicore processor, and may also be constituted by a combination of any of the processors and a processing circuit such as an application specific integrated circuit (ASIC) and a field-programmable gate array (FPGA).

Examples of a best embodiment (best mode) of the data processing method and the program (recording medium) according to the present disclosure include event data processing on a receiver side in a data transmission system between a transmitter and a receiver using an event camera. The system is constituted by the event camera, the transmitter, the receiver, and a processor on the receiver side. Output data from the event camera are transmitted to the receiver via the transmitter, and the processing method and the program (recording medium) according to the present disclosure are implemented in the receiver and the processor mounted on the receiver. By the implementation of the present technique, a memory use amount of an event buffer can be greatly reduced in a use in which high load processing and real-time responsiveness are required, such as high-speed moving object tracking and surrounding environment recognition in self-driving vehicles. Particularly, the present technique is useful for an event-based vision system that has been rapidly widespread in recent years. In an application that needs real-time large-capacity data processing in cooperation with hardware, such as the automobile industry, a drone technology, a security system, and an augmented reality (AR) device, the present disclosure produces an improvement in processing efficiency and system responsiveness, and provides significant technical superiority to the conventional technique.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A data processing method for processing event data that are output from two-dimensionally arrayed capturing pixels, and include a position of a capturing pixel having luminance changed, a time of the change in luminance, and polarity of the change, the data processing method comprising:
detecting a movement vector indicating a time change in a position of an event occurrence region constituted by a connected pixel group of the capturing pixels that output event data having the same polarity of a change among a plurality of pieces of event data output from the capturing pixels;
predicting an observation position of the event data output from the capturing pixel at a future observation time, based on the movement vector; and
updating the observation position of the event data output from the capturing pixel at the future observation time, based on the event data observed at the predicted observation time and in the predicted observation position.

2. The data processing method according to claim 1, wherein the detecting includes
specifying, as a superimposition region where an event occurrence region overlaps in a direction of a time axis, a region of the connected pixel group where a bit pattern indicating time fluctuations in luminance and being constituted by event data indicating the same position among a plurality of pieces of event data temporarily stored in a buffer memory coincides with a preset unique bit pattern,
specifying, as an event occurrence region based on the plurality of pieces of event data temporarily stored in the buffer memory, a region including the superimposition region and being constituted by a connected pixel group having the same polarity of a change as the superimposition region, and
detecting the movement vector, based on a position of an event occurrence region at a different time.

3. The data processing method according to claim 2, wherein the detecting includes deleting, from the buffer memory, event data that do not produce the unique bit pattern.

4. The data processing method according to claim 2, wherein the predicting includes deleting, from the buffer memory, event data indicating a position included in an event occurrence region where the movement vector is detected.

5. The data processing method according to claim 1, further comprising:
performing decoding of a bit pattern corresponding to a plurality of pieces of event data observed at the predicted observation time and in the predicted observation position.

6. The data processing method according to claim 5, wherein
the detecting includes detecting a position of an event occurrence region in a time unit corresponding to one bit of the bit pattern, and
the predicting includes predicting the observation position in a time unit corresponding to one bit of the bit pattern.

7. The data processing method according to claim 1, wherein the event data are processed by a modulation mode using at least one of four-valued pulse position modulation, amplitude shift keying, phase shift keying, or sinusoidal amplitude modulation.

8. The data processing method according to claim 1, wherein the event data are transmitted to a communication medium by using at least one of visible light, infrared light, ultraviolet light, or a terahertz wave.

9. A data processing system for processing event data that are output from two-dimensionally arrayed capturing pixels, and include a position of a capturing pixel having luminance changed, a time of the change in luminance, and polarity of the change, the data processing system comprising:
a detecting unit that detects a movement vector indicating a time change in a position of an event occurrence region constituted by a connected pixel group of the capturing pixels that output event data having the same polarity of a change among a plurality of pieces of event data output from the capturing pixels;
a predicting unit that predicts an observation position of the event data output from the capturing pixel at a future observation time, based on the movement vector; and
an updating unit that updates the observation position of the event data output from the capturing pixel at the future observation time, based on the event data observed at the predicted observation time and in the predicted observation position.

10. A non-transitory computer-readable recording medium recording a program for causing a computer to execute,
the computer processing event data that are output from two-dimensionally arrayed capturing pixels, and include a position of a capturing pixel having luminance changed, a time of the change in luminance, and polarity of the change:
a detection step of detecting a movement vector indicating a time change in a position of an event occurrence region constituted by a connected pixel group of the capturing pixels that output event data having the same polarity of a change among a plurality of pieces of event data output from the capturing pixels;
a prediction step of predicting an observation position of the event data output from the capturing pixel at a future observation time, based on the movement vector; and
an updating step of updating the observation position of the event data output from the capturing pixel at the future observation time, based on the event data observed at the observation time and in the observation position that are predicted in the prediction step.
